(19) United States
(12) Patent Application Publication
(10) Pub. No.: US 2005/0036822 A1
(43) Pub. Date: Feb. 17, 2005

(54) Pen

(76) Inventor: Lian Wang, San Gabriel, CA (US)

Correspondence Address: LIAN WANG, 1617 S. EUCLID AVE., SAN GABRIEL, CA, 91776, US

(21) Appl. No.: 10/641,171

(22) Filed: Aug. 14, 2003

(51) Int. Cl. B43K 5/02

(52) U.S. Cl. 401/232; 401/222

(57) ABSTRACT

A pen, comprising: a tip for writing, a tongue means for supplying ink for said tip, a neck assembling said tip and said tongue means together, a storage for storing ink, a pen rod, and a pen cap for protecting said tip, characterized by further comprising a divider provided in said storage, dividing said storage into a first storage chamber and a second storage chamber, and, a shifter for making said divider close or open. The pen according to the invention stores sufficient ink and suffers no leakage.

### FIELD OF THE INVENTION

The present invention relates to a pen.

### BACKGROUND OF THE INVENTION

Currently, pens on market are of various types and forms and have common defects: 1) insufficient ink storage which leads to frequent refills; 2) ink leakage caused by the structure of pens per se, and increased capacity of ink storage would worsen the pen structure and bring more ink leakage; 3) since the tip portion of a pen is open structured, not only leakage would be easily caused, but the tip would be often dried making it difficult to write if it is not used for a long time. Consequently, a pen can not compete with a ball-pen which may be easily used without frequent refill of ink and leakage. And to prevent the above problems, most of pens have to be refilled with ink just before being used, causing much inconvenience.

### SUMMARY OF THE INVENTION

One objective of the present invention is to provide a pen which stores sufficient ink and suffers no leakage. The pen according to the present invention has a divider dividing an ink storage into a first storage chamber and a second storage chamber, and a shifter for closing and opening said divider, and may be used as a ball-pen with a resistibility to ink leakage twice more than that of ordinary pen and has a storage of ink as more as 2 to 5 times of that of ordinary pen, eliminating the defects of previous pens.

Another objective of the present invention is to provide a leading means between a tongue means and a tip, which has one end connected to said shifter or has a shifting head mounted thereon, making the ink flowing from said first ink chamber to the second rapidly lead to the tip portion of the pen for writing words.

Another objective of the present invention is to provide a second ink chamber partially or totally made of transparent materials, making the ink storage in the second chamber clearly visible for easy use and timely refill of ink and prolonging life time of use of a pen.

A further objective of the present invention is to provide a brush means on said shifter or on a air tube, so as to better prevent accumulation of something dirty on the inner surface of said second chamber ensuring the transparency of the second chamber and visibility of ink storage in the chambers.

The objectives of the present invention are achieved in such a way that the pen comprises: a tip for writing, a tongue means for providing ink for said tip, a neck for assembling said tip and tongue means together, a storage for storing ink, a pen rod and a pen cap for protecting said tip, characterized by further comprising a divider provided within said storage making it divided into a first storage chamber and a second storage chamber, and a shifter for closing or opening said divider.

One further embodiment of the present invention is that said storage comprises, within a passage, a constriction port which has a sealing means, i.e. said divider, provided thereon, and said sealing means has a shifting means which partially protrudes out of said tip or said neck and may close or open said constriction port in respect of said sealing means when pulled or pushed.

A second embodiment of the present invention is that said storage comprises, within a passage, a constriction port which has a sealing means, i.e. said divider, provided thereon, wherein an air tube is fixed to said sealing means and extends into said first storage chamber, and at the lower end of said air tube or within said pen rod there is provided a shifter which, when pulled or down-pressed, closes or opens said constriction port.

In the above two embodiments, there is a reset spring provided on said shifter or air tube.

Further, said tongue means and/or said tip have provided therein a leading means which has one end connected to said shifter or has a shifting head thereon.

Furthermore, said second storage chamber is partially or totally made of transparent materials, and said shifter or said air tube has a brush means.

And furthermore, said first storage chamber is screwed to said neck and has a sealing ring provided at its plane connection to said neck.

The pen according to the present invention has the advantages of self ink supply like a ball pen, sufficient ink storage, less times of ink refills, enhanced ability against leakage, and less unwanted block at the tongue means and the tip, suggesting notable progress compared with the prior art.

### BRIEF DESCRIPTION OF THE DRAWINGS

FIG. 1 is a structural sketch of the first embodiment of the present invention.

FIG. 2 is a structural illustration of the shifter in operation as shown by FIG. 1.

FIG. 3 is a sectional view showing portions of inner neck, brush means, fixing seat and shifter as shown in FIG. 1.

FIG. 4 is a drawing showing sectional structure of the second embodiment of the present invention.

FIG. 5 is a drawing showing sectional structure of the third embodiment of the present invention.

FIG. 6 is a drawing showing sectional structure of the fourth embodiment of the present invention.

FIG. 7 is a structural illustration of said shifter and said shifting head in operation as shown in FIG. 6.

FIG. 8 is a drawing showing sectional structure of the fifth embodiment of the present invention.

Wherein: 1—tip; 2—tongue means; 21—leak holder; 22—leading means; 23—shifting head; 3—neck; 31—inner neck; 311—protrusion; 32—outer neck; 321—transparent window; 4—storage; 4A —first storage chamber; 40—tail cap of said first storage chamber, 4B—second storage chamber; 41—constriction port; 42—sealing ring; 43—air tube; 44—soft tube; 5—pen rod; 51—tail cap; 6—pen cap; 7—divider; 7′—sealing means; 7″—ball-shaped sealing means; 71—reset spring; 8, 8′—shifter; 9—brush means, 91—fixing seat.

### DETAILED DESCRIPTION OF THE INVENTION

Next further description will be made to the present invention by reference to the drawings and embodiments.

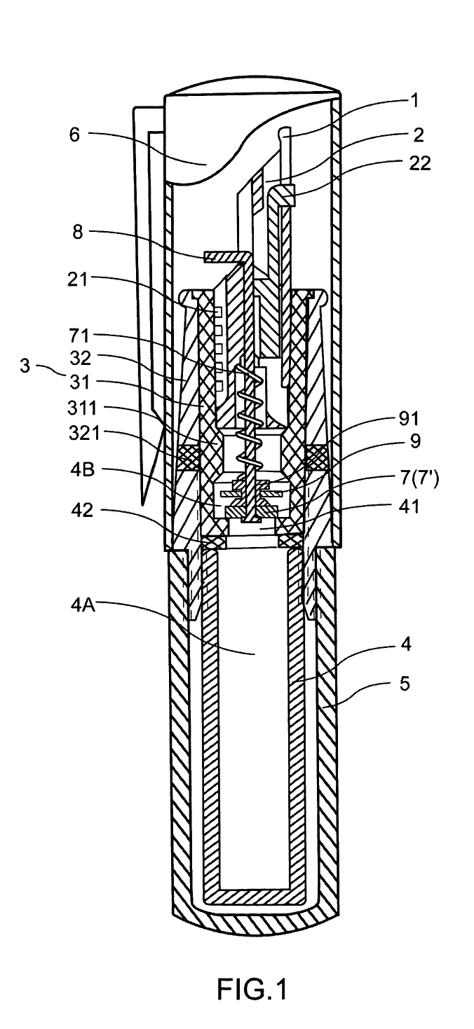

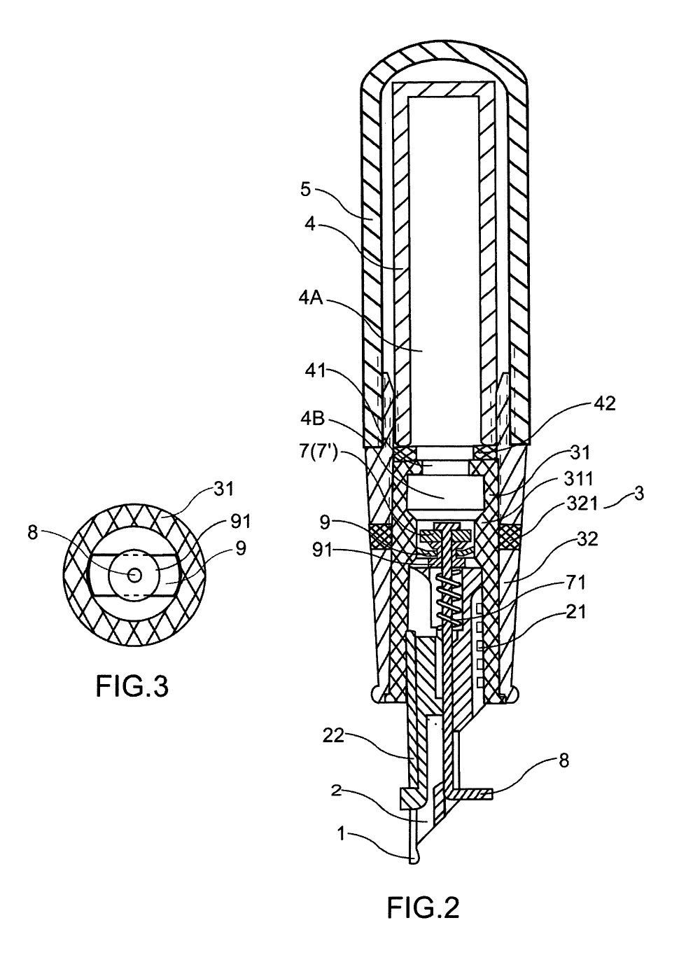

Refer to FIGS. 1 and 2. The pen according to the present invention comprises a tip 1 for writing, a tongue means 2 for supplying ink for said tip 1, a neck 3 assembling said tip land said tongue means 2 together, wherein there may also be provided with a leak holder 21 connected to said tongue means 2 and a storage 4, for holding up, to some extent, ink leak before the latter is pressed to said tongue means caused by difference of air pressure, a storage 4 for storing ink, a pen rod 5, and a pen cap for protecting said tip 1 etc., wherein there is provided in said storage 4 a divider 7 making said storage 4 divided into a first storage chamber 4A and a second storage chamber 4B, and a shifter 8 which closes or opens said divider 7. As shown in the drawing, said divider 7 may adopt a sealing means 7′ to divide said storage 4 into a first storage chamber 4A and a second storage chamber 4B, wherein said first storage chamber 4A may be assembled to said neck 3 by screw. In the process of assembly, said first storage chamber 4A may be first screwed off, and filled then with ink before screwed again onto said neck 3 by positioning the opening of said storage chamber 4 upward, so as to enable a pen with self ink supply. If the ink in the first storage chamber 4A is used up, the first storage chamber 4A may be screwed off and refilled with ink or replaced by another new first storage chamber 4A with ink. To prevent ink leakage and better the sealing between said first storage chamber 4A and said neck 3, a sealing ring 42 may be provided at the plan connection between said first storage chamber 4A and said neck 3, and to achieve better division within said storage 4 with divider 7, there is also provided with a constriction port within a passage of said storage, for which a preferred embodiment is that the middle portion of a passage of said storage 4 is made into a shape of constriction port 41, i.e. the portion between said first storage chamber 4A and said second storage chamber 4B is made into a shape of constriction port 41, so that a sealing means 7′ of said divider 7 may effect opening or closing under said constriction port 41. The advantages of such structure is that the peripheral gap of said sealing means 7′ in the second storage chamber may be enlarged, so that when said sealing means 7′ leaves said constriction port 41, the ink in the first storage chamber 4A may smoothly flow into said second storage chamber 4B by way of said peripheral gap of said second storage chamber 4B. The diameter of said constriction port is preferably larger than 3 mm.

As shown by the drawing, there is a shifter 8 provided on said sealing means 7′, which partially extends out of said tongue means 2 and may also partially protrudes out of neck 3 for easy operation by user's finger. When said shifter 8 is pulled down, said sealing means 7′ removes from said constriction port 41 making it open and leading part of ink in the storage chamber 4A into said second storage chamber 4B, and when the latter i.e. storage chamber 4B is filled up with ink, said sealing means 7′ effectively closes said constriction port 41 sectioning the pressure and effect of the ink from the first storage chamber 4A at the operation of a reset spring 71 provided on said shifter 8. In such a case, the first storage chamber 4A, a relatively larger storage chamber, may not affect said second storage chamber 4B having smaller ink storage room and less air pressure, and consequently the ink may not be easily pressed out from said pen tip, achieving better anti-leak results. In addition, since the two storage chambers 4A and 4B are two separate independent ink banks, the first storage chamber, as long as allowed by the size of a pen per se, may be made as large as possible, so as to obtain the result of larger storage, less refills and longer use.

To make ink flow smoothly from said second storage chamber 4B into said tip 1, a leading means 22 may be provided in said tip land tongue means 2, which is connected to said shifter 8 and preferably made of a thin sheet. When said shifter 8 is pulled downwards, making ink from said storage chamber 4A flow quickly into said second storage chamber 4B, said leading means 22 also slides in said tip 1 and tongue means 2, leading the ink in the second storage chamber 4B rapidly into said tip 1 so as to be able to achieve rapid, smooth and easy writing effects, and furthermore to prevent block at the tip 1 or tongue means 2. Said neck 3 may be totally or partially made of transparent materials to make visually known the amount of ink in said first storage chamber 4A and second storage chamber 4B. For easy manufacture, said neck 3 may be divided into inner neck 31 and outer neck 32, wherein said inner neck 31 may be totally made of transparent materials and said outer neck 32 may have its middle portion made of transparent materials in a shape of window 321 housing therein said inner neck 31, making visible the ink amount in the second storage chamber 4B and avoiding inappropriate stronger force imposed on the tip by the user due to the unawareness of ink amount stored. To prevent dirt accumulated in said transparent window of said second storage chamber 4B after a long period of time of use, a brush means 9 made of sealing ring or some soft materials (see FIG. 3) may be provided on said shifter 8. Refer to FIG. 2, said brush means 9 mainly moves to and fro along with the movement of shifter 8 to brush said inner neck 31 at the window 321. Additionally inner neck 31 may have its portion corresponding to said transparent window 321 of outer neck 32 made into a shape of protrusion 311, so that when said shifter 8 moves downwards, said brush means 9 may brush said protrusion 311 effecting better transparent results for good view of ink amount in said second storage chamber. When said shifter 8 moves back due to the resilient force of said reset spring 71, it brings said brush means 9 to leave away from said protrusion 311 (see FIG. 1), making brush means 9 in a released state without brushing said inner neck 31, which may enhance the brushing result since the resilience of the soft material of said brush means 9 is not affected in the state. As said brush means 9 only brushes a small portion within said inner neck 31, said brush means 9 may be made into a shape of long rim to prevent ink squeeze from said inner neck 31 caused by the movement of said brush means 9, leaving some gap when said brush means 9 moves in said circular inner neck 31. See FIG. 3. To make said brush means 9 better brush, a fixing seat 91 may be provided on said shifter 8 or said air tube 43 and has said brush means 9 fixed thereon, see FIG. 1. Additionally a soft sealing means 7 may lean on said fixing seat 9 for support when said sealing means 7 seals said constriction port 41. Further, one end of said spring means 71 on said shifter 8 may lean on said fixing seat 91 so as to prevent said brush means 9 from any adverse affect.

Once the ink stored in said second storage chamber 4B is reduced, it may be soon discovered from said transparent window 321. As long as the writing head of said tip 1 is put in downwards direction, mere pulling of said shifter 8 may bring the ink in said chamber 4A to said second storage chamber 4B, and said leading means 22 then brings ink to said tip 1 for easy and convenient writing.

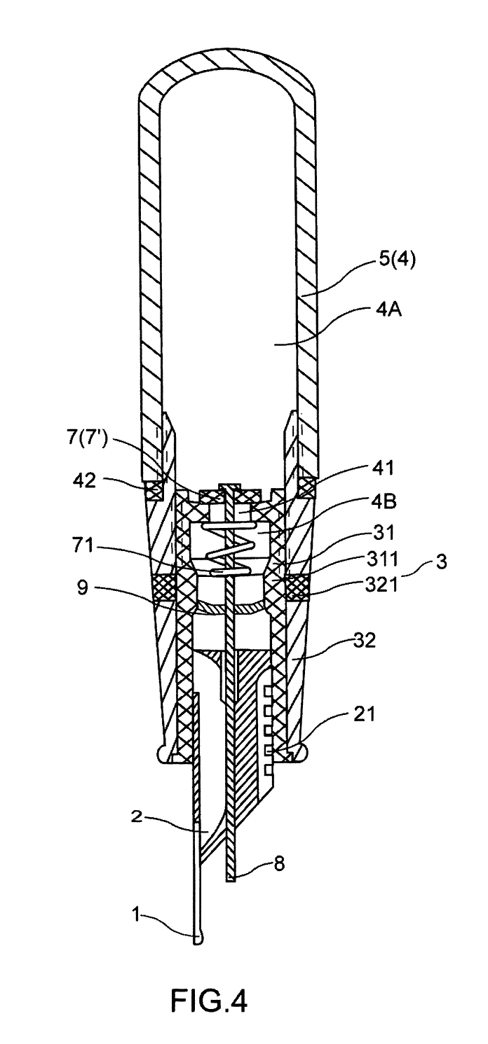

Refer to FIG. 4, said divider 7 of the embodiment has its sealing means 7′ provided at the upper side of said constriction port 41 and connected to said shifter 8, and said reset spring 71 has one end fixed to said shifter 8 and the other end supported on the lower side of said constriction port 41. When said shifter 8 is moved upwards by a user's finger, said sealing means 7′ leaves away from said constriction port 41, thus making the ink in said first storage chamber 4A flow rapidly into said second storage chamber 4B and then in turn to said tip 1 via guiding slot of said tongue means 2, and when said shifter 8 is released by user's finger, said sealing means 7′ blocks said constriction port 41, separating the ink of said first storage chamber 4A and that of second storage chamber 4B. Since during the process of writing, only the second storage chamber 4B with a small capacity provides ink for said tip, the resistance of the pen to ink leak has been greatly enhanced. Further, the first storage chamber 4A of the storage 4 may be integrated with the pen rod 5, so as to simplify the constructions thereof and increase the storage of ink therein.

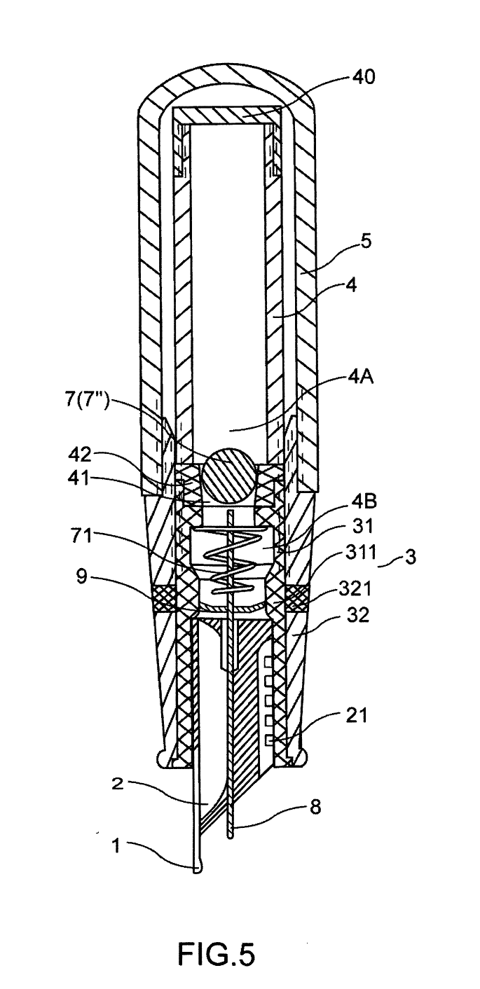

See FIG. 5. The embodiment as shown in the drawing is similar to that of FIG. 4, with difference in that said divider 7 adopts a ball-like sealing means 7′ which utilizes its weight per se to seal the bevel of said constriction port 41. To make said ball-like sealing means 7′ seal better the bevel of said constriction port 41, the hole of said sealing ring 42 in the passage of said storage 4 may be made into a constriction port 41 and the ball-like sealing means 7′ may be provided above said shifter 8. When moved upwards, said shifter 8 moves in contact with said ball-like sealing means 7′, propping up the latter from the bevel of said constriction port 41 so as to open the constriction port 41. Meanwhile, the ink in said first storage chamber 4A rapidly flows into said second storage chamber 4B. When said shifter 8 is released, the ball-like sealing means 7′ seals again said constriction port 41 dividing said first storage chamber 4A and said second storage chamber 4B. Further, a tail cap 40 is provided at the tail portion of said first storage chamber 4A, and when the ink in said first storage chamber 4A has been used up, said tail cap 40 may be turned off for pouring ink in from an opening of said tail portion of said first storage chamber 4A, and then said tail cap 40 may be screwed on again. Thus the tip may be kept clean and it is easy to refill ink thereto.

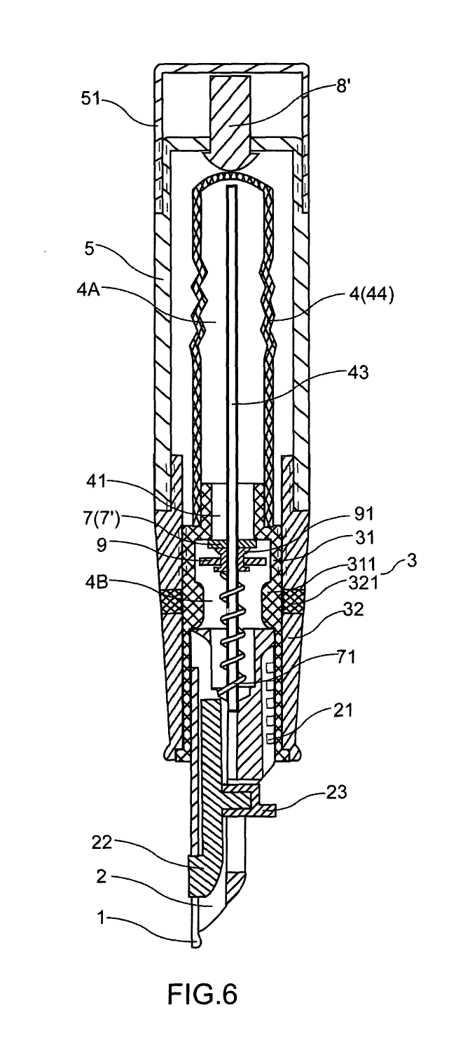

Refer to FIG. 6. A pen according to the present invention comprises a tip 1, a tongue means 2 for supplying ink for said tip 1, a neck 3 for assembling said tip 1 and tongue means 2 together, a storage 4 for storing ink, a pen rod 5, and a cap 6 for protecting said tip 1, wherein there is provided in said storage 4 a divider 7 dividing said storage 4 into a first storage chamber 4A and a second storage chamber 4B, and a shifter 8 for closing and opening said divider 7. As shown by the drawing, said divider 7 may have a sealing means 7′ for dividing said storage 4 into a first storage chamber 4A and a second storage chamber 4B. To better the separation of said storage 4 with said sealing means 7′ of said divider 7, there is provided in the passage of said storage a constriction port, which may be preferably achieved by making the middle portion of its passage of said storage 4 into a constriction port 41, i.e. the conjunction between said first storage chamber 4A and said second storage chamber 4B may be made into a relatively small port of constriction 41. Thus said sealing means 7′ of said divider 7 may close or open at the lower side of said constriction port 41. Such structure is advantageous in that the peripheral rim of said sealing means 7′ in said second storage chamber 4B has increased gap which may lead ink in said first storage chamber 4A rapidly to said second storage chamber 4B via said gap around said second storage chamber 4B. Preferably the diameter of said constriction port 41 is larger than 3 mm.

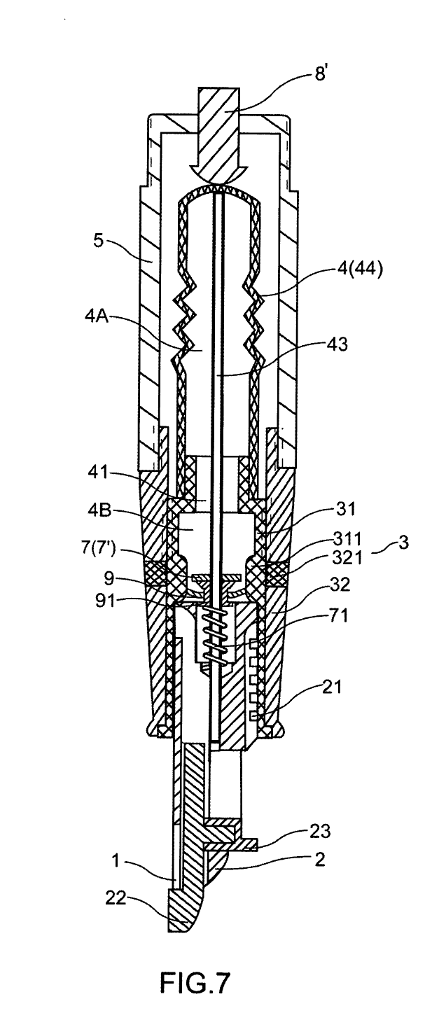

Said air tube 43 is fixed onto said sealing means 7′ and extends to said first storage chamber 4A. Said first storage chamber 4A may be a soft tube 44, which may, when immerged into ink and squeezed by user's hand, expel the air therein out via a hole in said air tube 43, and drawing the ink thereinto via said air tube 43. See FIG. 6. Said pen rod 5 has at its tail portion a shifter 8′. To prevent said shifter 8′ from vulnerably protruding out of the tail portion of said pen rod 5, a tail cap 51 may be screwed onto said tail portion of said pen rod 5. When there is need to use said shifter 8′, said tail cap 51 may be screwed off, and when said shifter 8′ is pressed downwards (see FIG. 7), said shifter 8′ presses down said soft tube 44, bringing indirectly said air tube 43 which is fixed on said sealing means 7′ to move downwards away from said constriction port 41 and open said constriction port 41. Thus ink in said first storage chamber 4A is led into said second storage chamber 4B. And when said second storage chamber 4B is filled with ink, said sealing means 7′ must effectively closes said constriction port 41 to ward off the affect or pressure onto said second storage chamber 4B caused by the ink in said first storage chamber 4A. Consequently a reset spring 71 is provided on said air tube 43, and when said shifter 8′ is released by user's finger, said reset spring 71 forces said sealing means 7′ to seal up said constriction port 41 holding back the ink of said first storage chamber 4A. In such a case, the first storage chamber 4A, a relatively larger storage chamber, may not affect said second storage chamber 4B having smaller ink storage room and less air pressure, and consequently the ink may not be easily pressed out from said pen tip, achieving better anti-leak results. In addition, since the two storage chambers 4A and 4B are two separate independent ink banks, the first storage chamber, as long as allowed by the size of a pen per se, may be made as large as possible, so as to obtain the result of larger storage, less refills and longer use. To make ink flow smoothly from said second storage chamber 4B into said tip 1, a leading means 22 may be provided in said tip land tongue means 2, which may independently have a shifting head 23 (see FIG. 6) and preferably made of a thin sheet. When said shifter 8 is pulled downwards, making ink from said storage chamber 4A flow quickly into said second storage chamber 4B, said shifting head 23 makes said leading means 22 slide in said tip 1 and tongue means 2 (see FIG. 7), leading the ink in the second storage chamber 4B rapidly into said tip 1 so as to be able to achieve rapid, smooth and easy writing effects, and furthermore to prevent block at the tip 1 or tongue means 2. To prevent dirt accumulated at said transparent window 321 of said second storage chamber 4B after a long period of time of use, a brush means 9 made of sealing ring or some soft materials (see FIG. 3) may be provided on said air tube 43. Refer to FIG. 6, said brush means 9 mainly moves to and fro along with the movement of shifter 8′ to brush said inner neck 31 at the window 321. Additionally inner neck 31 may have its portion corresponding to said transparent window 321 of outer neck 32 made into a protrusion 311, so that when said air tube 43 moves downwards, said brush means 9 may brush said protrusion 311 effecting better transparent results. When said shifter 8′ is released, said air tube 43, due to the resilient force of said reset spring 71, brings said brush means 9 to leave away from said protrusion 311 (see FIG. 6), making brush means 9 in a released state without brushing said inner neck 31, which may enhance the brushing result since the resilience of the soft material of said brush means 9 is not affected in the state.

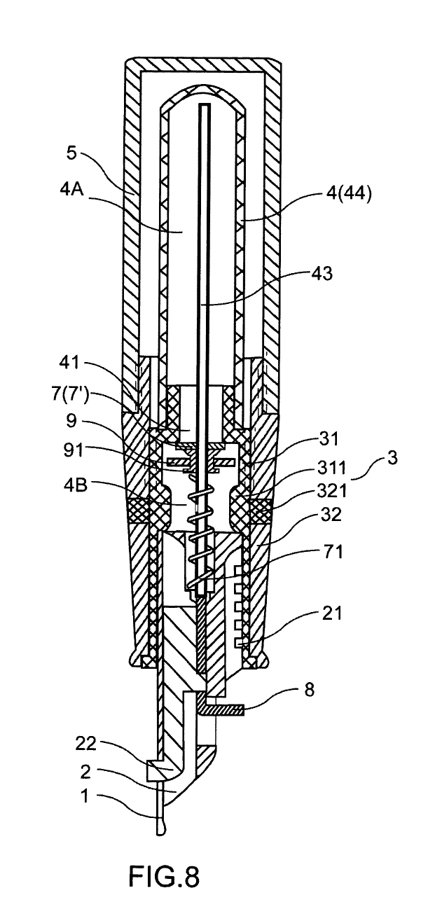

Refer to FIG. 8. The technical solution according to the present invention is similar to that as shown in FIG. 6 with difference in that said shifter 8 is provided under said air tube 43 and connected to said air tube 43, and pulling of said shifter 8 moves said sealing means 7′ away from said constriction port 41, making it open.

Though the present invention has been described in details by reference to the drawings and embodiments, it should be understood by those skilled in the art that the aforementioned embodiments are only for description of the invention and not in any case limitation to the present invention, and various modifications or variations which fall within the protective scope of the present invention could be made within the scope of the invention.

1. A pen comprising:
a tip for writing, a tongue means for supplying ink for said tip, a neck assembling said tip and said tongue means together, a storage for storing ink, a pen rod, and a pen cap for protecting said tip, characterized by further comprising a divider provided in said storage, dividing said storage into a first storage chamber and a second storage chamber, and, a shifter for making said divider close or open.

2. A pen as claimed in claim 1, characterized in that said storage comprises in its passage a constriction port, and said divider is a sealing means provided on said constriction port, and a shifter is provided on said sealing means and protrudes partially out of said tongue means neck, making, when pulled or pushed, said sealing means close or open in respect of said constriction port.

3. A pen as claimed in claim 1, characterized in that said storage comprises in its passage a constriction port, and said divider is a sealing means provided on said constriction port, and an air tube is fixed onto said sealing means, and said air tube extends to said first storage chamber and has a shifter provided at its lower end or in the pen rod, and said shifter, when pulled or pressed downwards, makes said sealing means in respect of constriction port sealed or opened.

4. A pen as claimed in claim 2 or 3, characterized in that there is a reset spring provided on said shifter or air tube.

5. A pen as claimed in claim 1 or 2 or 3, characterized in that said a leading means is provided in said tongue means or said tip and has one end connected to said shifter.

6. A pen as claimed in claim 1 or 2 or 3, characterized in that a leading means is provided in said tip or tongue means and has thereon a shifting head.

7. A pen as claimed in claim 1 or 2 or 3, characterized in that said second storage chamber is partially or totally made of transparent materials.

8. A pen as claimed in claim 7, characterized in that a brush means is provided on said shifter or air tube.

9. A pen as claimed in claim 1 or 2 or 3, characterized in that said first storage chamber is screwed to connect said neck.

10. A pen as claimed in claim 9, characterized in that a sealing means is provided at plane connection between said first storage chamber and said neck.
